(19) United States
(12) Patent Application Publication
(10) Pub. No.: US 2019/0225053 A1
(43) Pub. Date: Jul. 25, 2019

(54) TEMPERATURE CONTROL DEVICE ESPECIALLY FOR HEATING AN INTERIOR SPACE OF A VEHICLE AND/OR UNITS OF THE VEHICLE

(71) Applicant: FORD GLOBAL TECHNOLOGIES, LLC, Dearborn, MI (US)

(72) Inventors: Bernd Dienhart, Koeln (DE); Andreas Bock, Langenfeld (DE)

(21) Appl. No.: 16/254,510

(22) Filed: Jan. 22, 2019

(30) Foreign Application Priority Data
Jan. 22, 2018 (DE) 102018200938.4

(51) Int. Cl. B60H 1/22; B29C 45/14

(52) U.S. Cl. CPC B60H 1/2218; B29K 2101/12; B60H 1/2225; B29C 45/14639

(57) ABSTRACT

A temperature control device for heating an interior space of a vehicle and/or units of the vehicle, includes a number of electrically operated heating elements, electric leads, by means of which the heating element can be connected to the voltage supply of the vehicle, and at least one heat transfer section. A fluid flows through the at least one heat transfer section and transfers the heat generated by the heating elements to a fluid. The at least one heat transfer section includes a thermally conductive first material, and the heating elements and the electric leads are enclosed by an electrically non-conductive and thermally conductive second material. A related method is also disclosed for producing the present temperature control device.

### TECHNICAL FIELD

The present disclosure relates to a temperature control device especially for heating an interior space of a vehicle and/or units of the vehicle.

### BACKGROUND

On account of the fact that modern internal combustion engines of vehicles are becoming increasingly more efficient, they provide an ever decreasing amount of waste heat which can be used for heating the interior space of the vehicle and/or units of the vehicle, for example the vehicle's battery. Since electric motors of electric vehicles generate practically no waste heat, the engine has completely ceased to act as a heat source. In both cases, therefore, use is made of temperature control devices, sometimes also referred to as auxiliary heaters, which have electrically operated heating elements for providing the necessary heat.

Known temperature control devices have at least one heat transfer section through which, or around which, flows a fluid and which transfers the heat generated by the heating elements to the fluid. The heat transfer section is connected to the heating elements in order to enable a conductive heat conduction. The heat transfer section has for example fins around which air can flow. The fins are produced from a thermally good conductive material, usually from a metal such as aluminum. So that the heating elements can be supplied with electric power, provision has to be made for electric leads by means of which the heating elements can be connected to the voltage supply of the vehicle.

In the temperature control devices, a decoupling is necessary between the thermally conductive heat transfer sections and the electrically conductive components such as the electric leads. Since, however, aluminum is not only thermally but also electrically conductive, known temperature control devices, as are described for example in U.S. Pat. No. 7,399,948 B2, have a plastic frame for the decoupling. Further temperature control devices of this type are known from EP 1 407 907 A1, EP 1 839 920 A1, EP 1 933 598 A1, U.S. Pat. No. 5,206,476 A and US 2017/0113511 A1. On account of the high number of different materials and the complex construction, the production and the installation of known temperature control devices of this type are time and cost intensive. Automatization is hardly possible so that the production is carried out totally or partially manually.

### SUMMARY

It is an object of this document to develop the temperature control devices of the type referred to in the introduction so that the production and the installation can be designed in a simplified and less costly manner.

This object is achieved by means of the features which are specified in the following claims.

One embodiment relates to a temperature control device for heating an interior space of a vehicle and/or units of the vehicle. That device comprises a number of electrically operated heating elements, electric leads, by means of which the heating elements can be connected to the voltage supply of the vehicle, and at least one heat transfer section through which a fluid can flow and which transfers the heat generated by the heating elements to the fluid. The at least one heat transfer section comprises a thermally conductive first material, and the heating elements and the electric leads are enclosed by an electrically non-conductive and thermally conductive second material.

Within the context of the following description, a thermally conductive material means a material which has a thermal conductivity approximately in the range of between 15 and 500 W/mK. For example, aluminum (Al) has a thermal conductivity of 235 W/mK and iron (Fe) has a thermal conductivity of 80.2 W/mK.

Within the context of the following description, an electrically non-conductive material means a material which has an electrical conductivity of <10⁻¹ S/m. For example, glass has an electrical conductivity of 0.01 S/m and porcelain has an electrical conductivity of 0.001 S/m.

The use of the thermally conductive first material in the heat transfer section ensures that the heat generated by the heating element can easily be transferred to the fluid which flows around, or flows through, the heat transfer section. The use of the second material, which is thermally conductive and electrically non-conductive, ensures that the electric leads and the heating element are electrically insulated and therefore there is no risk of a short circuit arising. At the same time, the second material, on account of the thermal conductivity, does not prevent the transporting of heat from the heating element to the heat transfer section in contrast to materials which are used in known temperature control devices. The heat transfer section can for example be produced from aluminum or can at least contain aluminum. On account of the electrically insulating effect of the second material no further measures have to be taken for decoupling the heat transfer section from the electric leads, the construction of the temperature control device can be simplified so that the production and the installation can be simplified and the costs associated therewith can be reduced.

In a developed embodiment, the first material and the second material can be the same material which is electrically non-conductive and thermally conductive. As described previously, the heat transfer section is to ensure an effective transfer of the heat provided by the heating element to the fluid. In this case, it depends on a high thermal conductivity. Electrically conductive first materials can therefore only be used since the second material is electrically insulating. The second material, however, is not only electrically insulating but has a high level of thermal conductivity so that the second material can also be used for the heat transfer section. Consequently, the number of materials used for the temperature control device can be reduced, which further simplifies production and installation. In particular, interactions between the first and the second materials in this embodiment do not have to be taken into consideration in the design of the temperature control device.

In a further developed embodiment, the temperature control device can comprise a third material which is thermally non-conductive. As mentioned in the introduction, the temperature control device serves especially for heating the interior space of a vehicle and/or for heating units such as a vehicle battery. Consequently, the temperature control device has to be fastened in the vehicle. The third material is for example used where the temperature control device is in contact with adjacent components of the vehicle for the fastening. Due to the fact that the third material is thermally non-conductive, the effect of heat being transferred to components which do not have to be heated and/or which could be damaged on account of the heating is prevented.

In a further embodiment, the first material, the second material and/or the third material can be an injection moldable plastic. Injection moldable plastics can be thermoplastics such as PA (polyamide), PBT (polybutylene terephthalate) or PPS (polyphenylene sulfide). The plastics, for example polymers and these thermoplastics, are not electrically and thermally conducting in the initial state. In order to provide them with the desired thermal conductivity, however, they can be provided with additives such as graphite, carbon fibers or a suitable ceramic. The use of injectionable plastics enables the temperature control device to be produced entirely in the injection molding process. In this case, the heating elements and the electric leads can be pre-positioned in the injection mold by means of corresponding cores and pins and then coated. In this case, it is easily possible to inject not only one material but a plurality of materials in an injection molding process. Even when the temperature control device comprises a plurality of materials, the temperature control device can be produced in a so-called “one-shot molding process” by which it is understood that the injection mold has to be closed and opened only once in order to completely produce the temperature control device. The production times and the production costs are minimized as a result of this.

One embodiment is distinguished by the fact that the heating element is a posistor. A posistor is also referred to as a positive temperature coefficient thermistor (PTC element) which has a positive temperature coefficient so that it conducts the electric current better at low temperatures than at high temperatures. If the PTC element is operated at constant voltage, it functions in a self-regulating manner If the PTC element is operated so that it releases a lot of heat, it also correspondingly heats up itself. Since, however, with rising temperature the heat capacity generated by it falls, it cools down again. Occurrences of overheating are therefore avoided.

The PTC element can be used not only for heating the interior space or the additional units but also for their cooling. Also, the range of application of the temperature control device according to the proposal especially according to this embodiment with the PTC element is not limited to the temperature control of the interior space or of the units of vehicles. The temperature control device can also be used for example for cooling computers and servers. In this respect, the temperature control device may not only be used for heating the interior space and units of vehicles, but also for cooling heat-generating and heat-endangered IT components, especially servers and computers. In this case, heat is extracted from the fluid so that the heat is transferred from the fluid to the heat transfer section.

In a further embodiment, the temperature control device comprises a terminal section by means of which the temperature control device can be connected to the voltage supply of the vehicle. The terminal section can be designed so that it can be connected to the established connector in the vehicle body. The integration of the temperature control device into the power electronics of the vehicle is therefore possible without great expenditure.

In accordance with an additional aspect, a method is provided for producing a temperature control device according to one of the preceding embodiments, wherein the temperature control device is produced in a “one-shot molding process”.

In accordance with yet another aspect, a motor vehicle is provided, comprising a temperature control device according to one of the previously discussed embodiments and/or to a temperature control device which is produced according to a method according to the embodiment which is explained above.

The technical effects and advantages, which can be achieved with the method according to the proposal and with the proposed vehicle, correspond to those which have been discussed for the previously presented temperature control device.

In summary, reference may be made to the fact that the construction of the temperature control device can be designed so that it can be produced in the injection molding process. Moreover, the injection molding process can be designed as a “one-shot molding process” in which for the production of the temperature control device the injection mold needs to be closed and opened only once. As a result of this, the production costs and the production times for the temperature control device can be minimized The vehicle which is equipped with the temperature control device can be produced correspondingly more favorably.

### BRIEF DESCRIPTION OF THE DRAWING FIGURES

Exemplary embodiments are explained in more detail below with reference to the attached drawings. In the drawings:

FIG. 1a shows a schematic view of an embodiment of the new and improved temperature control device,

FIG. 1b shows an enlarged view of the region X which is identified in FIG. 1a, and

FIG. 2 shows a schematic plan view of a vehicle which is equipped with the temperature control device shown in FIGS. 1a and 1b.

### DETAILED DESCRIPTION

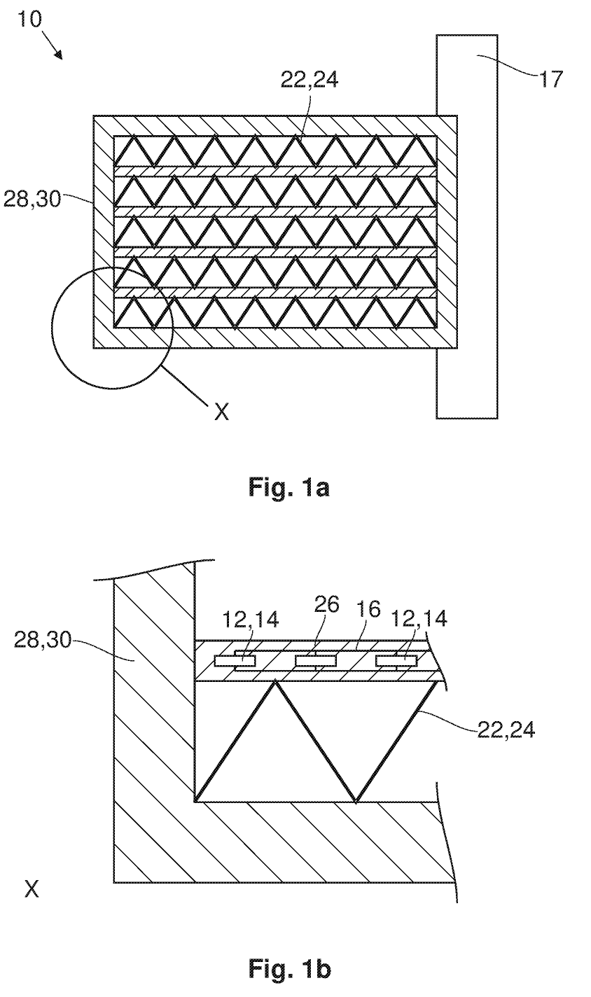

Shown in FIG. 1a is a schematic view of an embodiment of a temperature control device 10 and shown in FIG. 1b is an enlarged view of the region X which is identified in FIG. 1a. Therefore, the following description relates equally to FIGS. 1a and 1b.

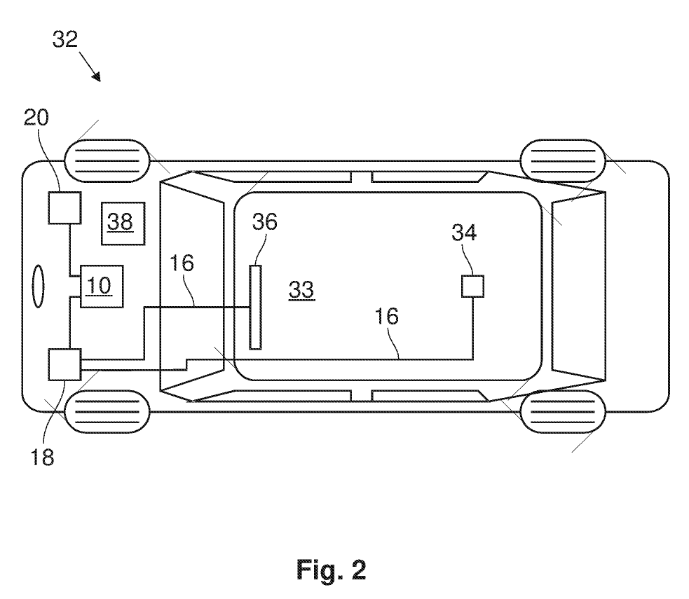

The temperature control device 10 has a number of electrically operated heating elements 12 which in the depicted embodiment are designed as posistors 14. The heating elements 12 are connected by means of electric leads 16 to a terminal section 17 by means of which the temperature control device 10 can be connected to the onboard electronics of a vehicle 32, especially to a control unit 18 and a voltage supply 20 (see FIG. 2). Moreover, the power electronics of the heating element 12 and especially of the posistors 14 can be accommodated in the terminal section 17. As is evident from FIG. 1b, the heating elements 12 are connected in parallel.

Furthermore, the temperature control device 10 has a plurality of heat transfer sections 22 through which flows a fluid, especially air. In the depicted example, the heat transfer sections 22 are produced from a first material 24 which is thermally conductive, for example from aluminum.

The heating element 12 and the electric leads 16 are enclosed by a second material 26 which is thermally conductive and electrically insulating and acts with supporting effect. The second material 26 is in contact with the first material 24 so that the heat generated by the heating element 12 can be directed to the heat transfer section 22 and transferred to the fluid there.

Not shown is an embodiment in which the power electronics of the heating element 12, especially of the posistor 14, is also enclosed by the second material 26. The heat generated by the power electronics during operation can be directed via the second material 26 into the heat transfer section 22 and transferred to the fluid there, as a result of which the power loss is reduced.

Furthermore, the temperature control device 10 comprises a frame 28 which is produced from a third material 30 which is not thermally conductive. By means of the frame 28, the temperature control device 10 is fastened to the terminal section 17. The fact that the temperature control device 10 can be fastened by means of the frame 28 to adjacent components of the vehicle 32 is not shown.

For the first material 24, the second material 26 and the third material 30, use can be made of injection moldable plastics which enable the temperature control device 10 to be produced by injection molding, as a result of which high piece numbers can be realized at low costs. The heating elements 12 and the electric leads 16 can be positioned in the injection mold by means of cores and pins and then coated by the second material 26. The heat transfer sections 22, and after that the frame 28, are then coated. Other production sequences are also conceivable. All the injection molding steps can be carried out without the injection mold being opened in the meantime so that the temperature control device 10 can be produced during the “one-shot molding process”. The production can be further simplified by at least the second material 26 being substituted at least for the first material 24 and therefore the number of materials used is reduced. However, it would make sense to produce the frame 28 from the third material 30 which is thermally non-conductive. As a result of this, the effect of the heat generated by the heating element 12 being dissipated to the adjacent components and therefore no longer being available for heating the fluid is prevented.

Shown in FIG. 2, based on a schematic plan view, is a vehicle 32 having an interior space 33. The vehicle 32 is equipped with a temperature control device 10 of the type previously described. The temperature control device 10 is connected by means of the electric leads 16 to the onboard electronics of the vehicle which include the control unit 18. The control unit 18 is connected to temperature measuring sensors 34 which measure the temperature in the interior space 33 of the vehicle. The control unit 18 is also connected to an interface 36 by means of which the driver can set the desired interior-space temperature. The interior-space temperature in the vehicle 32 can be regulated by means of corresponding algorithms which are stored in the control unit 18. At this point, it is to be noted that the use of the posistor 14, also referred to as a PTC element, enables the interior-space temperature not only to be increased but also to be lowered.

Furthermore, the temperature control device 10 is connected by the electric leads 16 to the voltage supply 20 which provides the electric power for operating the temperature control device 10. The vehicle 32 depicted in FIG. 2 is electrically operated and therefore has a vehicle battery 38 for driving an electric motor, which is not shown. The temperature control device 10 can also be used for the temperature control of the vehicle battery 38 or other units, not shown, of the vehicle. It is also conceivable that the temperature control device 10 is supplied with electric power from the vehicle battery 38 so that the voltage supply 20 is not required. The depicted isolation of the voltage supply 20 from the vehicle battery 38 is, however, sensible insofar as the vehicle battery 38 discharges more quickly especially at low outside temperatures than at moderate outside temperatures. As a result of the isolation of the voltage supply 20 from the vehicle battery 38, heating strategies can be realized, for example, in that after a specified time, with the falling short of a specified temperature, the temperature control device 10 is activated by the control unit 18 so that when the driver wants to begin the journey the vehicle battery 38 is warmed up without even having been demanded during the warm-up phase. As a result of this, the effect of the vehicle battery 38 discharging more quickly on account of the low outside temperatures can be prevented.

The temperature control device 10 can also be used when the vehicle 32 is driven by an internal combustion engine (not shown) which itself in fact provides waste heat but not always in sufficient measure in order to be able to heat for example the interior space 33 of the vehicle 32 to the desired temperature within a specified time. In this case, the temperature control device 10 does not act as the single heat source but interacts with the internal combustion engine, which is why the temperature control device 10 is also referred to as an auxiliary heater. Heating strategies which are designed quite like those which have been described for the vehicle battery 38 can be realized in this case also. Since the internal combustion engine operates optimally only at its operating temperature, the temperature control device 10 can be used for preheating the internal combustion engine and/or the engine oil and/or other components of the drive train, especially at low outside temperatures, in order to reach the operating temperature more quickly and therefore to reduce the use and the wear of the internal combustion engine and/or of the drive train.

What is claimed:

1. A temperature control device for heating an interior space of a vehicle and/or units of the vehicle, comprising:
a plurality of electrically operated heating elements;
electric leads connected to the plurality of electrically operated heating elements; and
at least one heat transfer section, wherein a fluid flows and heat generated by the plurality of electrically operated heating elements is transferred to the fluid,
said temperature control device being further characterized by said at least one heat transfer section including a thermally conductive first material, and
the plurality of electrically operated heating elements and the electric leads being enclosed by an electrically non-conductive and thermally conductive second material.

2. The temperature control device as claimed in claim 1, wherein the first material and the second material are made from the same material which is electrically non-conductive and thermally conductive.

3. The temperature control device as claimed in claim 2, further including a third material which is thermally non-conductive.

4. The temperature control device as claimed in claim 3, wherein the first material, the second material and the third material are all injection moldable plastics.

5. The temperature control device as claimed in claim 4, wherein the plurality of electrically operated heating elements are posistors.

6. The temperature control device as claimed in claim 5, further including a terminal section whereby the temperature control device is connected to a voltage supply of a vehicle.

7. The temperature control device as claimed in claim 1, further including a third material which is thermally non-conductive.

8. The temperature control device as claimed in claim 7, wherein the first material, the second material and the third material are all injection moldable plastics.

9. The temperature control device as claimed in claim 8, wherein the plurality of electrically operated heating elements are posistors.

10. The temperature control device as claimed in claim 9, further including a terminal section whereby the temperature control device is connected to a voltage supply of a vehicle.

11. The temperature control device as claimed in claim 1, wherein the plurality of electrically operated heating elements are posistors.

12. The temperature control device as claimed in claim 1, further including a terminal section whereby the temperature control device is connected to a voltage supply of a vehicle.

13. A vehicle comprising the temperature control device as claimed in claim 1.

14. A method for producing a temperature control device including a plurality of electrically operated heating elements, electric loads connected to said plurality of electrically operated heating elements and at least one heat transfer section, said method comprising:
producing said temperature control device by a one-shot molding process.

15. The method of claim 14 including positioning the plurality of electrically operated heating elements and electric leads into an injection mold.

16. The method of claim 15, including molding said at least one heat transfer section from a first plastic material.

17. The method of claim 16, including coating said plurality of electrically operated heating elements and electric leads with a second plastic material.

18. The method of claim 17, including molding a frame of said temperature control device from a third plastic material.

19. The method of claim 18, including using one plastic material for said first and second plastic material.
